(19) United States
(12) Patent Application Publication
(10) Pub. No.: US 2018/0304249 A1
(43) Pub. Date: Oct. 25, 2018

(54) CONTROLLED ATMOSPHERE BAG SUITABLE FOR MICROSCOPY AND SPECTROSCOPY

(71) Applicant: THE SECRETARY OF STATE FOR DEFENCE, London (GB)

(72) Inventors: Emma Grace HANDLEY, Reading (GB); Andrew Stuart KIRK, Reading (GB)

(21) Appl. No.: 15/758,979

(22) PCT Filed: Sep. 9, 2016
(86) PCT No.: PCT/GB2016/000164

§ 371 Date: Mar. 9, 2018

(30) Foreign Application Priority Data
Sep. 9, 2015 (GB) 1515961.9

(51) Int. Cl. B01L 1/02; G02B 21/24; G01N 21/01

(52) U.S. Cl. CPC B01L 1/025; G02B 21/24; B01L 2200/026; B01L 2300/123; G01N 21/01

(57) ABSTRACT

A controlled atmosphere bag suitable for microscopy and spectroscopy, having an optic attachment (7) a sample support attachment (6), gas inlet means (2), gas outlet means (4) and a sample insertion means (3) that allow a sample to be analysed to be enclosed in a relatively small and controlled gas atmosphere chamber allowing the remainder of the analysis device to remain outside the chamber retaining full dexterity for the operator.

This invention relates to a device for undertaking controlled atmosphere microscopy or spectroscopy

Microscopic or spectroscopic analysis of air-sensitive chemical, biological or other scientific samples can often be challenging, and sensitive substances often require analysis in conditioned environments where oxygen, water or other reactive atmospheric species are removed down to very low levels as compared to the ambient conditions.

Known examples of achieving this are through the use of Glove Box systems or environmental chambers such as those disclosed in U.S. Pat. No. 3,907,389(A).

These systems require investment in expensive permanent equipment which consume a significant amount of laboratory space and generally result in the analytical equipment being tied to the experimentation purpose for long periods.

A further disadvantage of these systems is the loss of dexterity to the operator having to operate through relatively thick impervious gloves.

Where the sample is moderately air-sensitive, or can tolerate exposure to low amounts of air for short periods, the conditions for analysis do not have to be quite so rigorous.

It is known in the art that a simpler solution comprising a chamber purged with an inert gas such as argon or nitrogen can be very effective, whilst costing substantially less than the more extensive systems described above. Such a setup can also be used for introduction of a controlled gas for exposure studies; e.g. an inert gas dosed to a specific moisture content.

US2007234829A1 reports a climate chamber designed for use with a microscope such that the sample can be observed directly with a Microscope. However this apparatus employs a rigid fixture with no opening to insert or remove samples as the housing is placed over the microscope once the sample is in place, rendering this design less suitable for air sensitive materials. Furthermore there are no means for internal handling of the sample e.g. to allow the sample to be placed in container to facilitate extraction under inert or controlled atmospheric conditions.

Reference Publication “The manipulation of air-sensitive compounds” D. F. SHRIVER & M. A. DREZDZON 2^{nd} Edition 1934, discloses the use of a glove bag that can be purged with inert gases to form an enclosed moderately air-free environment, allowing handling or containment of articles. Such glove bags are used to entirely contain the analysis device and samples. However, analysis devices can often be large or complicated, which can necessitate either the modification of the bag (e.g. making holes), or the partial disassembly of the analysis device, or both.

For example using a microscope inside a glove bag can be achieved by making a hole in the top of the glove bag, removing the eyepieces of the microscope, placing the body of the instrument inside the bag, inserting the neck through the hole, connecting the eyepieces back on the microscope from the outside, and sealing the bag to the microscope neck. This is necessary so that the bag does not obscure the view through the eyepieces. However, this is a time consuming process, and cannot be achieved where microscopes cannot be disassembled and/or are connected to other larger equipment such as optical spectrometers. Additionally, such glove bags need to be particularly large to accommodate large analysis devices, which when purged with gas can involve the consumption of large amounts of gas. This is not ideal from both a cost and a safety perspective, as inert gas such as argon is both expensive in large quantities and is also an asphyxiate. Moreover due to the enclosure of the analytical equipment there is again a loss of dexterity for the operator of the analytical equipment.

There is therefore a need for a cheap, quick, reversible, small, safe and effective device to permit direct observation of samples in a controlled atmosphere using standard laboratory equipment without requiring their disassembly and retaining the operator's dexterity over the analytical device.

According to a first aspect of the invention, there is provided a controlled atmosphere bag suitable for microscopy comprising: an optical attachment providing optical access to the interior of the bag; a sample support stage attachment coupling the bag to the microscope sample support stage; and an isolation chamber formed between the optical attachment and the sample support attachment capable of substantially isolating a sample from the external environment while leaving the remainder of the microscope unenclosed; Characterised in that; the isolation chamber is formed of a flexible material such that relative movement of the sample support stage to the optical attachment is possible in all degrees of freedom.

A key advantage of the device is the fact that the bag forms only a small enclosure chamber around the sample and just a small element of the optical portion of the analytical instrument resulting in the majority of the instrument remaining outside the bag and free to use as an operator would under normal laboratory conditions, without requiring any modification to the equipment thus greatly improving upon its ease of use and less overall burden for the operator.

A further advantage is achieved through the fixation of the bag through the sample support attachment such that upon movement of the interrogator sample support structure by the operator the sample to be analysed is correspondingly so moved.

Another advantage due to the small size of the bag relative to that known in the art is that it can be more easily handled allowing it to be quickly positioned in situ, purged, used and removed with ease.

A further advantage is that the device when in situ requires the use of less inert control gas for air sensitive microscopy or spectroscopy so has economic as well as safety benefits over what is known in the art.

Optionally, the optical attachment further comprises an integral o ring that is expandable circumferentially. This allows a simple and quick method of temporarily attaching the bag to the optical portion of the interrogator. It will be apparent to a person skilled in the art that other embodiments of this may include having a simple hole in the flexible bag which may then be coupled or attached to the optical portion of the interrogator though a mechanical or chemical adherent means which may include clips, hook and loop, glue, tack or tape.

Optionally, the optical attachment further comprises a re-sealable aperture. This sealing mechanism in combination with the other features described below has the advantage that the internal bag environment can, once at a desired composition (either from preparatory activities carried out inside a glove box or through purging through the gas inlet and gas outlet means), be maintained upon removal of the device from any glove box usage or from removal of the device from the microscope, gas inlet and outlet means thus allowing the device to act as a temporary environmental transport container.

Optionally, the sample support stage attachment comprises sample support frame having a longitudinal slot opening to couple to a sample support surface such as a traditional glass microscope slide. Upon inserting a glass microscope slide by sliding it into the slot it will effectively form a frictional interference fit sealing the opening. This has the advantage that it allows radiant light to be focussed on the sample having only to pass through the glass microscope slide and not further inhibited by transmission through the flexible material. It further means that by insertion of the sample support attachment into the microscope the bag is attached to the microscope support structure and any desired movement of the microscope support surface will correspondingly effect movement of the bag and the sample enclosed therein. In a more simplistic arrangement the sample support attachment may be provided by an adherent to simply attach the flexible material to the microscope and the support frame having a longitudinal slot opening would be omitted. It will be apparent to a person skilled in the art that by adherent it is foreseen to include mechanical or chemical adherent means which may include clips, hook and loop, glue, tack or tape to attach to the interrogator

Optionally the bag may have a re-sealable sample insertion means. The opening provides a simple access opening that a sample in its container may be inserted into the bag, the sample insertion opening can then be resealed allowing the internal atmosphere to reach its desired controlled condition before the sample is extracted from its container using the flexibility of the bag to open the container. It is foreseen that the sample insertion means in its simplest form may also be provided through insertion of the sample in its container through the optical attachment means in which case the re-sealable opening may be omitted.

Optionally the bag further comprises a gas inlet means. This has the benefit that the bag may first be positioned for use on the analytical instrument and then the internal gaseous environment may be controlled through introduction of a control gas via the gas inlet means. It would be apparent that in this instance the other instrument attachments, and particularly the optical attachment would allow the control gas to purge past such that a positive pressure within the bag can be maintained.

Optionally the bag would further comprise a gas outlet means. This has the benefit that the gas is allowed to purge outwardly from the bag chamber in a controlled manner. It would be apparent that the volumetric flow capabilities of the gas outlet can be determined with respect to the gas inlet volumetric capabilities such, that a positive pressure can be maintained within the bag chamber.

Optionally the flexible material is comprised of a polymeric based material that is transparent to the interrogating radiation. This has the advantage that the material forms a gas impervious barrier layer, allows the sample to be illuminated from below where necessary and also allows visual identification and manipulation of the sample from its container to the desired position. It will be apparent to a person skilled in the art that there may be other variations of material transmissivity which may also be used in order to provide distinct analytical qualities.

Optionally the gas inlet and gas outlet means would each comprise a uni-directional valve. The one way valve allows the device to be disconnected from the gas supply and gas outlet lines whilst ensuring the internal desired environmental composition is maintained such that the device may act as a temporary environmental transport environment.

The invention will now be described solely by way of example and with reference to the accompanying drawings in which:

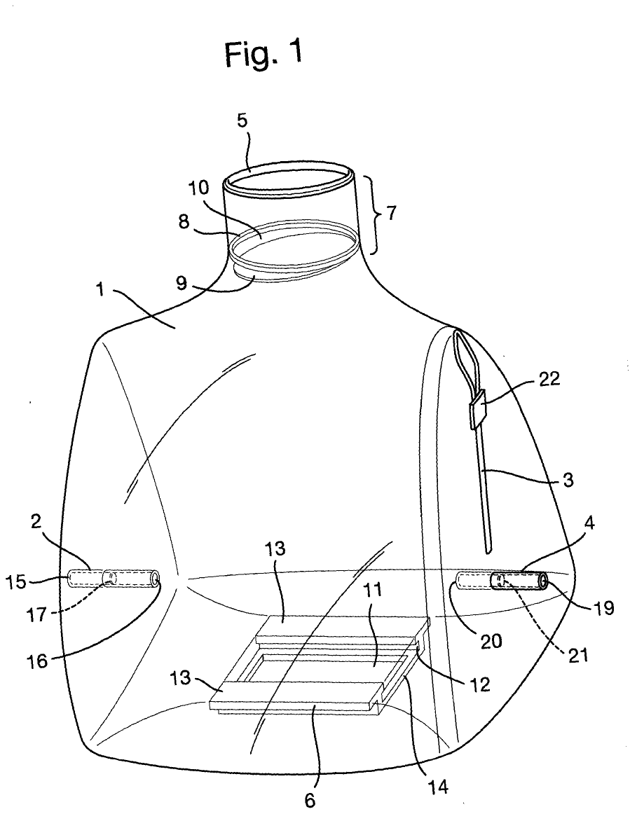

FIG. 1 shows the controlled atmosphere bag

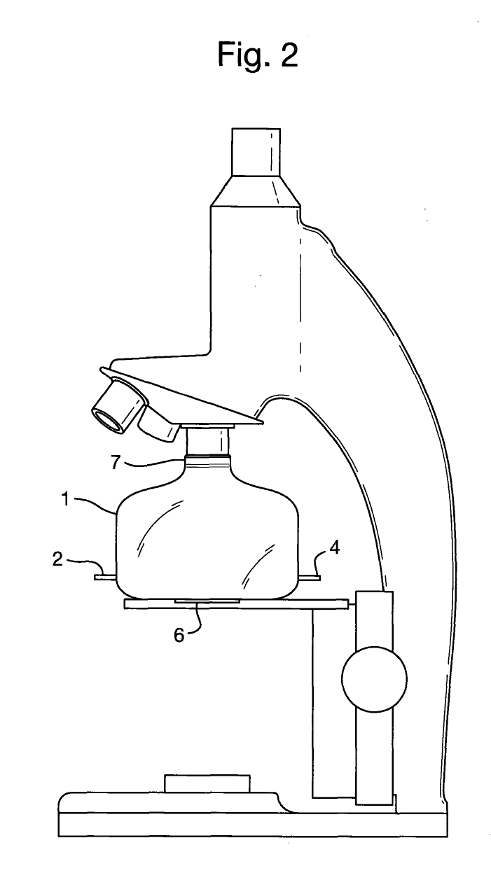

FIG. 2 shows the controlled atmosphere bag in situ mounted to a standard microscope.

FIG. 1 shows the controlled atmosphere bag, which in use encloses a sample to be studied through Microscopy or Spectroscopy. The bag encloses an internal gas chamber environment which can be controlled such that specific atmospheric conditions can be achieved in order to carry out analysis in this environment. The bag is suitably sized such that it only encloses the end of the microscope optical portion and the sample itself. This leaves the remainder of the analysis equipment available for normal usage by the operator.

The flexible transparent polymeric material 1 forms the bag which encloses the sample to be studied. The material is of a polymeric structure such that it provides a gas impervious barrier with which to enclose an internal gas atmosphere. The material is transparent and flexible so as to allow visual manipulation of the sample, by the operator, out of its potential container and into the desired position ready for analysis on a standard Microscope (Microscope is used herein after but includes Spectrograhy equipment). The bags relative flexibility allows the movement of the sample once in the desired position by movement of the support structure of the Microscope, the flexibility further allowing in use the lower portion to move relative to the upper fixed attachment to the Microscope optic potion. It will be apparent that in order to provide alternative conditions for specific spectroscopy it is perceivable that the transmissivity of the material may be varied.

The optic attachment 7, has a stretchable ‘o ring’ 5 that is integrally formed into the flexible material 1, so that it may be expanded circumferentially allowing for the insertion of the Microscope optical portion. The ‘o ring’ 5 will upon removal of the expanding force, decrease circumferentially to its rest position or until it meets the circumference of the Microscope optical portion and in so doing form a frictional seal or grip around the optical portion of the Microscope. In its most simplistic form the optic attachment may be achieved by cutting a hole through the flexible material 1 and simply taping or coupling it to the optical portion, this is foreseen to include hook and loop as well as all adherent means.

Upon insertion of the Microscope optical portion into the optic attachment 7, it will force open a re-sealable aperture 10. The re-sealable aperture 10 comprises a sealing ring 8 which is coupled to or integrally formed to the flexible material 1, the sealing rings inner diameter forming an opening which is sealed by the sealing flap 9 that is biased to a closed position. The re-sealable aperture means that the interrogator optical portion can be removed from the internal atmosphere, allowing the aperture to seal it inside which then allows the removal the optical attachment. This ensures that the internal atmosphere can be preserved allowing the device to act as a transportation device for the sample. It will be apparent however that this feature is a beneficial one but not essential to attain a controlled atmosphere and hence in other embodiments may be omitted entirely.

The sample support attachment 6 is adhered to or integrally formed into the flexible material 1 and comprises an opening 11 which is then sealed by the insertion of a standard microscope glass slide (not shown) into the slot 12 formed by the two rails 13 which extend beyond the opening 11 at both longitudinal ends. This allows the assembly to form a sealed support surface for the sample and permits radiant energy to be directed from below to illuminate the sample. The lower portion 14 having similar rectangular dimensions as the microscope glass slide, can be inserted into the Microscope support surface such that the whole sample support assembly becomes attached to the Microscope support stage. A movement of the Microscope stage will therefore effect a corresponding movement of the lower portion of the controlled atmosphere bag whereas the upper portion remains attached to the optical portion of the microscope. Whilst this embodiment is more preferential it is clear that other embodiments are foreseen and in its most simplistic form the sample support attachment 6, may simply be achieved by coupling the flexible material 1 to the Microscope stage with any adherent or coupling means.

In order to allow the internal atmosphere of the bag to be controlled a gas inlet means 2 is adhered to or integrally formed into and through the flexible material 1. This permits a desired gas medium to be introduced into the opening 15 and to pass through the flexible material 1 and out of the opening 16 into the internal bag environment. The gas inlet means comprising a conduit and having a one way valve such that a higher differential pressure from outside the bag to inside will cause an inward flow of gas however should the internal pressure be differentially higher to the outside it will force the valve shut sealing the pipe. This in conjunction with the other sealing means of the invention, allows the connection of a controlled laboratory gas medium source and for it to be removed whilst maintaining the internal bag environment. In another embodiment it is foreseen that both the gas inlet means and the gas outlet means may be omitted from the device and the sample and bag environment are pre-prepared for subsequent analysis inside a glove box system, the remaining sealing features would allow the bag to be used as a temporary environmental transport container having enclosed a controlled atmosphere from the glove box. The Microscope optical portion is then inserted through the optic attachment 7.

The gas outlet means 4 is adhered to or integrally formed into the flexible material 1. This permits the internal gas medium to purge through opening 20 through the flexible material and out of the opening 19 either to ambient or for removal by standard laboratory equipment. The gas outlet means comprising a conduit and having a one way valve such that a higher differential pressure inside the bag will cause an outward flow of gas however should there be a differentially higher pressure outside the bag the valve will remain shut sealing the conduit. The pressure biasing of valve 21 being greater than valve 17 such that an overall positive internal bag pressure is maintained so as to minimise any inward leakage from any other locations of the invention. Whilst this is a preferential embodiment, it will be apparent that the gas outlet means 4 may in its most rudimentary form be provided by allowing the internal bag environment gas medium to purge past the optical attachment 7 or past the sample insertion means 3.

The sample insertion means 3, is comprised of an opening which permits a sample to be inserted into the bag (whilst still in its protective container for air sensitive samples), and to be placed on the sample support attachment 6. The sample insertion means can then be re-sealed by sliding the slider 22 longitudinally along the opening until reaching the termination of the opening. It will be apparent that in its most rudimentary form the sample insertion means may be provided by passing the sample through the optic attachment 7 prior to attaching it to the microscope.

Once the sample has been placed into the bag,and the internal environment has reached its desired gas composition, the sample can be extracted from its protective container by using the flexibility of the hand manipulatable material 1 to hand manipulate open the container and hand manipulate the sample onto the desired glass slide area of the sample support attachment 6. This process may be done preferentially prior to insertion or attachment of the sample support attachment into or onto the microscope stage to provide further flexibility.

Once the analysis of the sample has been completed the optic portion of the microscope can be removed through the re-sealable aperture 10 allowing it to close maintaining the internal environment and the overall optic attachment 7 may be then be detached.

After removal of the optic attachment the gas inlet means may be detached from the laboratory supply thus allowing the one way valve to return to its biased closed position again maintaining the internal gas environment.

After removal of the optic attachment and the gas inlet means the gas outlet means can be detached from any standard laboratory gas recovery equipment, this allows the one way valve 21 to return to its biased closed position maintaining the internal gas environment.

Upon extraction of the sample support attachment 6 from the Microscope stage the controlled atmosphere bag can be used as a temporary environmental transport container. Whilst it is preferable that these steps are performed in this sequence they may be performed in other variations and with the omission of some of the features it should not detract from the inventions ability to provide a controlled gas environment for Microscopy or Spectroscopy.

FIG. 2 shows the controlled atmosphere bag in situ such that it may be apparent that the majority of the Microscope remains unaffected and outside the bag and hence free to use normally.

1. A controlled atmosphere bag suitable for microscopy comprising:
An optical attachment providing optical access to the interior of the bag;
A sample support stage attachment coupling the bag to the microscope sample support stage; and
An isolation chamber formed between the optical attachment and the sample support attachment capable of substantially isolating a sample from the external environment while leaving the remainder of the microscope unenclosed;
Characterised in that;
the isolation chamber is formed of a flexible material such that relative movement of the sample support stage to the optical attachment is possible in all degrees of freedom.

2. A controlled atmosphere bag according to claim 1 characterised in that the optical attachment further comprises an integral o-ring that is expandable circumferentially.

3. A controlled atmosphere bag according to claim 1 characterised in that the optical attachment further comprises a re-sealable aperture.

4. A controlled atmosphere bag according to claim 1 characterised in that the sample support stage attachment comprises a support frame having a longitudinal slot opening to couple to a sample support surface such as a traditional glass microscope slide.

5. A controlled atmosphere bag according to claim 1 characterised in that the bag comprises a re-sealable sample insertion means.

6. A controlled atmosphere bag according to claim 1 characterised in that the bag comprises a gas inlet means.

7. A controlled atmosphere bag according to claim 1 characterised in that the bag comprises a gas outlet means.

8. A controlled atmosphere bag according to claim 1 characterised in that the gas inlet and gas outlet means each have a uni-directional valve.

9. A controlled atmosphere bag according to claim 1 characterised in that the flexible material is comprised of a polymeric based material that is transparent.
